(19) United States
(12) Patent Application Publication
(10) Pub. No.: US 2010/0136972 A1
(43) Pub. Date: Jun. 3, 2010

(54) GATEWAY MODULE, COMMUNICATION METHOD, AND COMPUTER PROGRAM PRODUCT THEREOF

(75) Inventors: Hung-Yun HSIEH, Taipei (TW); Chen-Yung LIAO, Pingtung City (TW); You-En LIN, Tanzi Town (TW); Kun-Hung LEE, Taipei (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/398,503

(22) Filed: Mar. 5, 2009

(30) Foreign Application Priority Data
Dec. 1, 2008 (TW) 097146588

(51) Int. Cl. H04W 36/00

(52) U.S. Cl. 455/436

(57) ABSTRACT

A gateway module, a communication method, and a computer program product thereof are provided. The gateway module is adapted for use in a network framework comprising a mobile station, a plurality of interworking units, a first wireless network, and a second wireless network. The mobile station is located within the signal coverage of the first wireless network and the second wireless network, and accepts network service provided by the first wireless network. The gateway module receives a handover request signal of the first wireless network, selects a handover interworking unit from the interworking units according to the handover request signal, and transmits the handover request signal to the second wireless network. Thereby, the mobile station can handover to the second wireless network to accept the network service provided by the second wireless network.

This application claims priority to Taiwan Patent Application No. 097146588 filed on Dec. 1, 2008.

### CROSS-REFERENCES TO RELATED APPLICATIONS

Not applicable.

### BACKGROUND OF THE INVENTION

1. Field of the Invention

The present invention provides a gateway module, a communication method and a computer program product thereof. More specifically, the present invention provides a gateway module, a communication method and a computer program product thereof for handover in a heterogeneous network.

2. Descriptions of the Related Art

With continuous advancement in science and technology, ever higher requirements are being imposed on communications. Nowadays, more and more importance is being attached to convenience of communications in addition to requirements on quality of communications. Among various communication means, wireless communications are advantageous in that they provide higher mobility by obviating the need of physical communication network wiring. Therefore, wireless-communication-enabled products such as cell phones, notebook computers and the like are gaining more and more popularity in recent years and have become the mainstream products in the consumer electronics market.

A product with wireless-communication function is generally portable with the user, and thus, it can be considered as a mobile station (MS). Because of the portability thereof, the mobile station often has to handover between two heterogeneous networks in order to maintain a certain level of quality of service (QoS) between, for example, a worldwide interoperability for microwave access (WiMAX) network and a 3G network. To accomplish the handover between heterogeneous networks smoothly, a single interworking unit between two heterogeneous networks is typically used in the prior art to provide a route for handover signal communication. Bandwidth and reliability of the route provided by the single interworking unit generally vary with level of the interworking unit.

However, conventional handover between heterogeneous networks is accomplished by only a single interworking unit, the route of which can only provide inflexible bandwidth and reliability. In other words, the route of such a single interworking unit cannot provide appropriate bandwidth and reliability according to an operation currently executed by the mobile station. For example, if the route of the single interworking unit has properties of small bandwidth and high reliability while the mobile station is transmitting a video stream for the user thereof to watch, these properties of the route will be inappropriate for the video transmission currently underway because such a video transmission generally requires larger bandwidth in order to avoid the delays of video frames. Consequently, this will result in low efficiency of the mobile station's handover between the heterogeneous networks.

Accordingly, a pressing need exists in the art to provide a solution capable of selecting appropriate interworking unit(s) according to the operation currently executed by a mobile station during handover between two heterogeneous networks, so that the handover of the mobile station can be accomplished smoothly and efficiently.

### SUMMARY OF THE INVENTION

One objective of the present invention is to provide a gateway module, a communication method and a computer program product thereof. The gateway module is adapted for use in a network framework comprising a mobile station, a plurality of interworking units, a first wireless network and a second wireless network. The first wireless network has a first signal coverage and provides a first network service. The second wireless network has a second signal coverage and provides a second network service. The mobile station is located within the first signal coverage and the second signal coverage. The interworking units are located between the first wireless network and the second wireless network. The mobile station is connected to the first network service beforehand. After receiving a handover request signal from the first wireless network, the gateway module selects a handover interworking unit from the interworking units according to the handover request signal so that the mobile station may handover from the first wireless network to the second wireless network via the handover interworking unit. Thereby, the network service originally provided by the first wireless network will now be provided by the second wireless network instead.

To this end, the gateway module of the present invention comprises a reception module, a process module and a transmission module. The reception module is configured to receive the handover request signal from the first wireless network. The process module is configured to select the handover interworking unit from the interworking units according to the handover request signal. The transmission module is configured to transmit the handover request signal to the second wireless network via the handover interworking unit so that the MS may handover to the second wireless network to connect to the second network service.

Also to this end, the communication method of the present invention is adapted for use in the gateway module, and comprises the steps of: receiving the handover request signal from the first wireless network; selecting the handover interworking unit from the interworking units according to the handover request signal; and transmitting the handover request signal to the second wireless network via the handover interworking unit so that the MS may handover to the second wireless network to connect to the second network service.

Further to this end, the computer program product of the present invention stores a program of a communication method for use in the gateway module. The program is loaded into the gateway module by a computer and comprises: a program instruction A for a reception module to receive the handover request signal from the first wireless network; a program instruction B for a process module to select the handover interworking unit from the interworking units according to the handover request signal; and a program instruction C for a transmission module to transmit the handover request signal to the second wireless network via the handover interworking unit so that the MS may handover to the second wireless network to connect to the second network service.

As described above, according to the handover request signal from the first wireless network, the present invention selects the handover interworking unit from the interworking units for use in handover of the mobile station to the second wireless network. Specifically, as the first wireless network is now providing the first network service to the mobile station, the handover request signal comprises the information corresponding to the first network service. According to the information corresponding to the first network service in the handover request signal, the present invention selects the handover interworking unit so that the bandwidth and reliability of the route provided by the handover interworking unit satisfy the needs of the first network service currently executed/received by the mobile station. Thereby, the mobile station may handover to the second wireless network smoothly and efficiently, and the shortcoming associated with using only a single interworking unit for the mobile station's handover in the prior art is overcome effectively.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a network framework of the first embodiment of the present invention;

FIG. 2 is a schematic view illustrating arrangement of interworking units in the first embodiment;

FIG. 3 is a schematic view of a gateway module of the first embodiment; and

FIG. 4 is a flowchart of the second embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from illustration; and dimensional relationships among individual elements in the attached drawings are illustrated only for ease of understanding, but not to limit the actual scale.

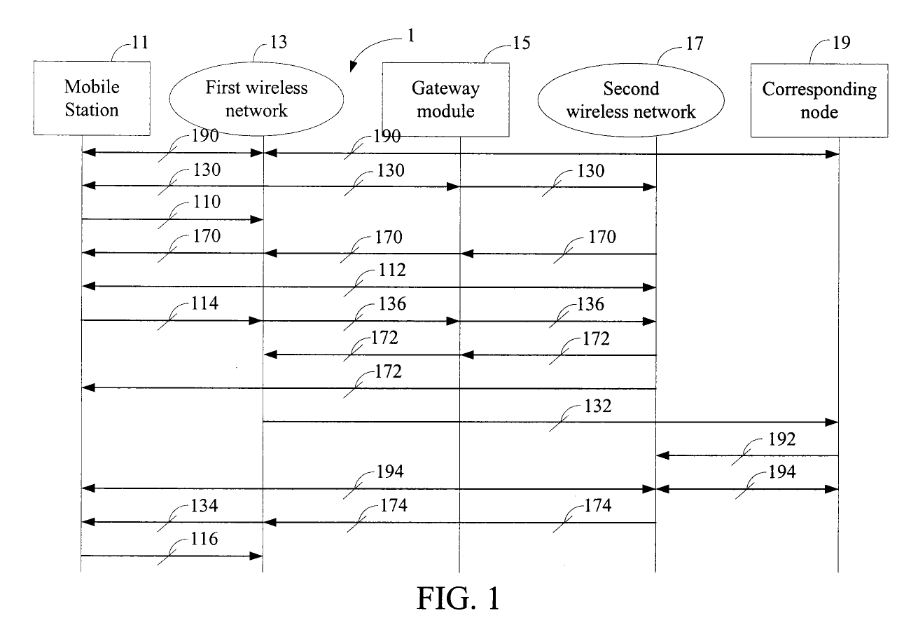

A first embodiment of the present invention is illustrated in FIG. 1, which is a schematic view of a network framework 1. The network framework 1 comprises a mobile station 11, a first wireless network 13, a gateway module 15, a second wireless network 17, a corresponding node 19 and a plurality of interworking units (not shown). In this embodiment, the first wireless network 13 is a network based on the 3G wireless network standards, and the second wireless network 17 is a WiMAX wireless network based on the IEEE 802.16 standards. It should be noted that, rather than being limited thereto, the first wireless network 13 and the second wireless network 17 may also be the networks based on other network standards in other embodiments.

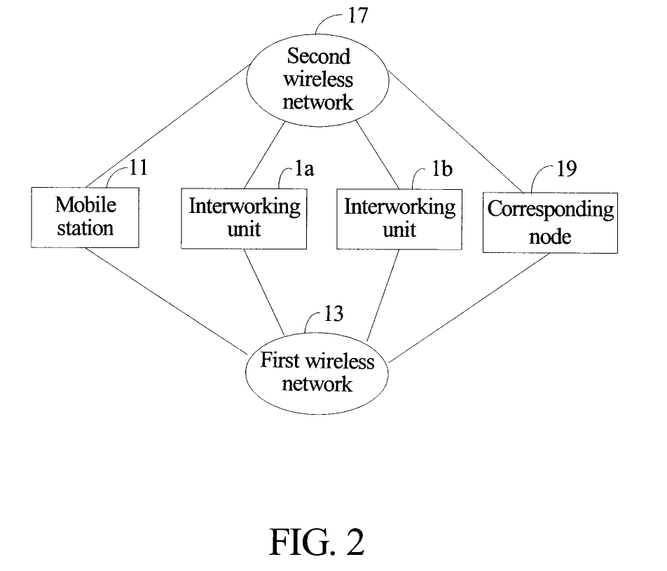

Furthermore, as the first wireless network 13 is based on the 3G wireless network standards, the first wireless network 13 comprises apparatuses that make it operable, such as a 3GPP AAA server, an SGSN, a GGSN, a UTARN or the like. Likewise as the second wireless network 17 is based on the WiMAX wireless network standards, the second wireless network 17 comprises apparatuses that make it operable, such as a base station, an ASN GW, a CSN, a WiMAX AAA server or the like. How these apparatuses comprised in the first wireless network 13 and the second wireless network 17 are connected and interact with each other is well known to those of ordinary skill in the art, and thus will not be further described herein. To make the following description more clearly, relationships between the interworking units and the mobile station 11, the first wireless network 13, the second wireless network 17, and the corresponding node 19 will be described first. Referring to FIG. 2, a schematic view of arrangement of the interworking units is shown therein. As can be seen in FIG. 2, the interworking units (i.e., the interworking units 1a and 1b) are located between the first wireless network 13 and the second wireless network 17 as a communication intermediary therebetween. How the mobile station 11, the first wireless network 13, the second wireless network 17 and the corresponding node 19 interact with the interworking units 1a and 1b will be detailed hereinafter.

The first wireless network 13 has a first signal coverage and provides a first network service 190. The second wireless network 17 has a second signal coverage and provides a second network service 194. The mobile station 11 and the corresponding node 19 are located within the first signal coverage of the first wireless network 13 and the second signal coverage of the second wireless network 17. The mobile station 11 is connected to the first network service 190 of the first wireless network 13 beforehand, for example, to execute image/voice transmission or the like with the corresponding node 19 via the first wireless network 13. Specifically, in this embodiment, the mobile station 11 may be considered as a mobile phone, a notebook computer or any other electronic product with a wireless Internet accessing capability, and is now connected with the first wireless network 13 and receives the first network service 190 therefrom to communicate with the corresponding node 19. The corresponding node 19 may be different apparatuses depending on the content of the first network service 190; for example, if the first network service 190 is voice transmission, the corresponding node 19 may be a cell phone communicating with the mobile station 11, and if the first network service 190 is image transmission, the corresponding node 19 may be an image server.

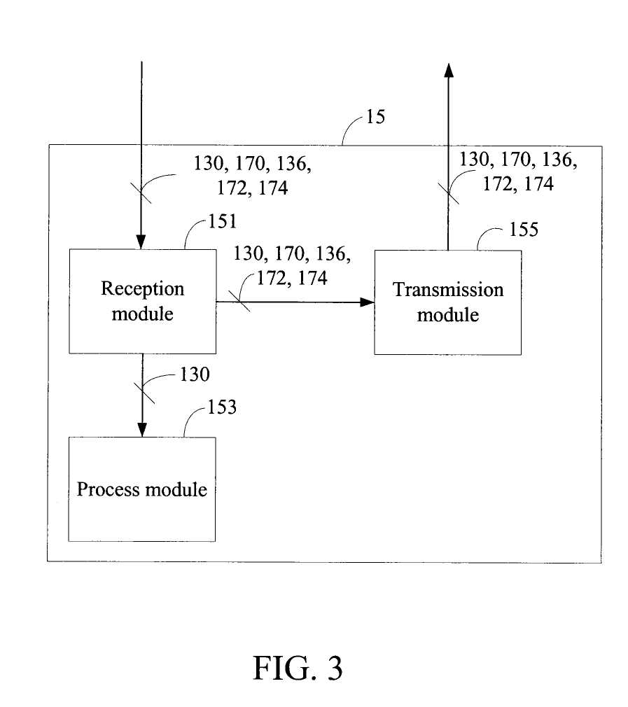

To explain the functions of the gateway module 15 in the network framework 1 in detail, please refer to FIG. 3 together, which is a schematic view of the gateway module 15. The gateway module 15 comprises a reception module 151, a process module 153 and a transmission module 155, the functions of which will be described hereinafter.

Assume that the user of the mobile station 11 is gradually moving away from the first signal coverage of the first wireless network 13 and has now entered the second signal coverage of the second wireless network 17. In other words, for the mobile station 11, signal strength received from the first wireless network 13 is fading away while that from the second wireless network 17 is becoming stronger gradually. Hence, to maintain a certain level of QoS, the first wireless network 13 transmits a handover request signal 130 to the mobile station 11 and the gateway module 15 to inform that the mobile station 11 shall handover to the second wireless network 17. After receiving the handover request signal 130, the mobile station 11 transmits a handover response signal 110 to the first wireless network 13 to inform the first wireless network 13 that the mobile station 11 is prepared for the handover.

On the other hand, after the reception module 151 of the gateway module 15 received the handover request signal 130 from the first wireless network 13, the process module 153 of the gateway module 15 selects, according to the handover request signal 130, a handover interworking unit from the interworking units for use as a communication intermediary between the first wireless network 13 and the second wireless network 17. As described above, in this embodiment, the network framework 1 comprises the interworking units 1a and 1b, so the process module 153 of the gateway module 15 selects a handover interworking unit from the interworking units 1a and 1b according to the handover request signal 130. Here, it is assumed that the interworking unit 1a is selected by the gateway module 15 as the handover interworking unit.

Particularly, in this embodiment, the handover request signal 130 at least comprises mobile station information and session information, and the process module 153 of the gateway module 15 selects the interworking unit 1a from the interworking units 1a and 1b as the handover interworking unit according to the mobile station information and the session information. It should be noted that, in other embodiments, rather than being limited thereto, the network framework 1 may comprise another number of interworking units.

Then, the transmission module 155 of the gateway module 15 transmits the handover request signal 130 to the second wireless network 17 via the interworking unit 1a so that the second wireless network 17 learns that the mobile station 11 will handover to the second wireless network 17 to connect to the second network service 194. To allow the mobile station 11 to handover to the second wireless network 17, the second wireless network 17, after receiving the handover request signal 130, transmits a handover response signal 170 having base station (BS) candidate information of the second wireless network 17. Then the reception module 151 of the gateway module 15 receives the handover response signal 170 via the interworking unit la, and the transmission module 155 of the gateway module 15 transmits the handover response signal 170 to the first wireless network 13. After receiving the handover response signal 170, the first wireless network 13 further transmits the handover response signal 170 to the mobile station 13.

According to the base station candidate information of the second wireless network 17 incorporated in the handover response signal 170, the mobile station 13 performs a selection procedure 112 with the second wireless network 17 and, from the base station candidate information, selects an appropriate base station for use to communicate with the second wireless network 17. Once the appropriate base station is selected, the mobile station 13 transmits a selection signal 114 to the first wireless network 13 which, according to the selection signal 114, generates and transmits a network resource allocation signal 136 to the gateway module 15. The reception module 151 of the gateway module 15 receives the network resource allocation signal 136 from the first wireless network 13, and then the transmission module 155 of the gateway module 15 transmits the network resource allocation signal 136 via the interworking unit 1a to the second wireless network 17 so that the second wireless network 17 can allocate a network resource thereof according to the network resource allocation signal 136. The network resource includes network bandwidth, network IP and quality of service.

After having allocated the network resource according to the network resource allocation signal 136, the second wireless network 17 transmits a network resource allocation response signal 172 comprising information relating to the network resource. Further, the reception module 151 of the gateway module 15 receives the network resource allocation response signal 172 from the second wireless network 17 via the interworking unit la, and the transmission module 155 of the gateway module 15 transmits the network resource allocation response signal 172 to the first wireless network 13 so that the first wireless network 13 confirms that the network resource of the second wireless network 17 is allocated.

On the other hand, as the second wireless network 17 has allocated the network resource according to the network resource allocation signal 136, the network resource allocation response signal 172 may be transmitted directly to the mobile station 11 from the second wireless network 17 so that the mobile station 11 can be informed of the network resource allocation of the second wireless network 17. In other words, the mobile station 11 is able to receive signals from both the first wireless network 13 and the second wireless network 17 to enhance reliability of the signals in the handover process.

Additionally, the corresponding node 19 now is still unaware that the mobile station 11 has initiated handover to the second wireless network 17, so the first wireless network 13 transmits a mobile IP update signal 132 to the corresponding node 19 to inform the corresponding node 19 that it shall communicate with the mobile station 11 via the second wireless network 17. After receiving the mobile IP update signal 132, the corresponding node 19 transmits a mobile IP confirmation signal 192 to the second wireless network 17 to confirm that the mobile station 11 has indeed completed handover to the second wireless network 17. Thereafter, the mobile station 11 may begin to communicate with the corresponding node 19 via the second network service 194.

After receiving the mobile IP confirmation signal 192 from the corresponding node 19, the second wireless network 17 further transmits a disable signal 174 to the first wireless network 13 via the interworking unit la, so as to disable the first network service 190 provided by the mobile station 11. After receiving the disable signal 174, the first wireless network 13 transmits a disable signal 134 to the mobile station 11 so that the mobile station 11 disables the GPRS function thereof according to the disable signal 134. Then, the mobile station 11 transmits a disable confirmation signal 116 to the first wireless network 13 to inform that the GPRS function of the mobile station 11 has been disabled indeed.

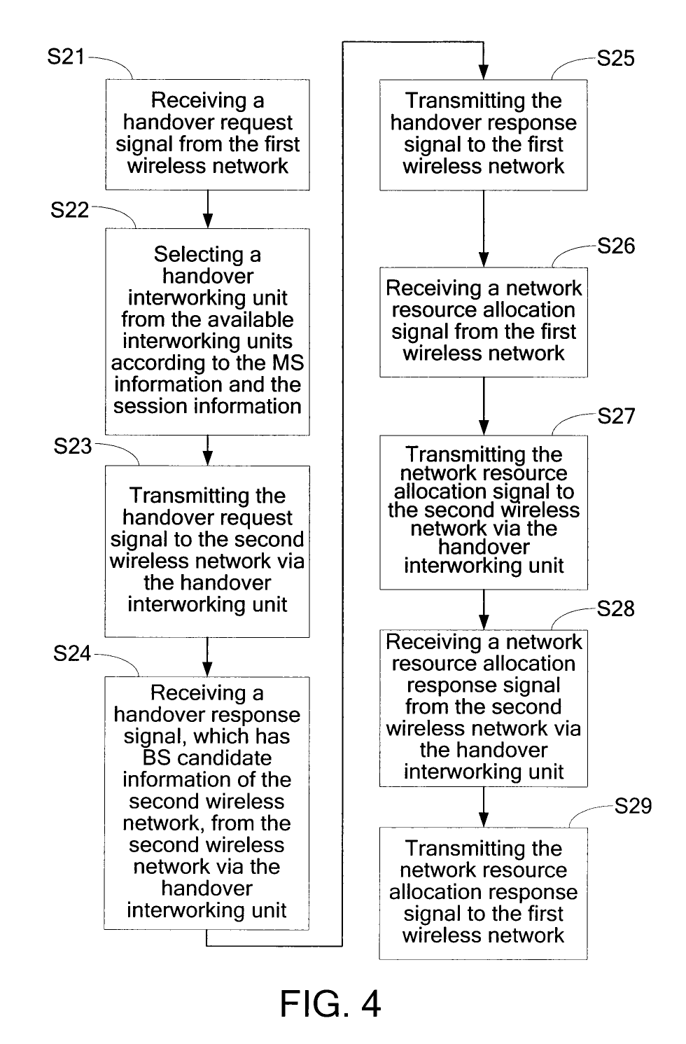

A second embodiment of the present invention is illustrated in FIG. 4, which is a communication method for use in the gateway module described in the first embodiment. The gateway module is adapted for use in a network framework comprising a mobile station, a plurality of interworking units, a first wireless network, and a second wireless network. The first wireless network has a first signal coverage and provides a first network service. The second wireless network has a second signal coverage and provides a second network service. The mobile station is located within the first signal coverage and the second signal coverage, the interworking units are located between the first wireless network and the second wireless network, and the mobile station is connected to the first network service beforehand. Specifically, the communication method described in the second embodiment may be executed by a computer program product. When the computer program product is loaded into the gateway module by a computer and a program embodied therein is executed, the communication method described in the second embodiment can be accomplished. The computer program product may be stored in a tangible machine-readable medium, such as a read only memory (ROM), a flash memory, a floppy disk, a hard disk, a compact disk (CD), a mobile disk, a magnetic tape, a database accessible to a network, or any other storage media with the same function and well known to those skilled in the art.

The communication method described in the second embodiment comprises the following steps. Initially, step S21 is executed to receive a handover request signal from the first wireless network, wherein the handover request signal comprises mobile station information and session information. Step S22 is executed to select a handover interworking unit from the interworking units according to the mobile station information and the session information. Then, step S23 is executed to transmit the handover request signal to the second wireless network via the handover interworking unit so that the mobile station may handover to the second wireless network to connect to the second network service.

Next, step S24 is executed to receive a handover response signal, which has base station candidate information of the second wireless network, from the second wireless network via the handover interworking unit after the second wireless network receives the handover request signal. Afterwards, step S25 is executed to transmit the handover response signal to the first wireless network so that the first wireless network receives the base station candidate information of the second wireless network. Then, step S26 is executed to receive a network resource allocation signal from the first wireless network, and step S27 is executed to transmit the network resource allocation signal to the second wireless network via the handover interworking unit so that the second wireless network allocates network resource of the second wireless network according to the network resource allocation signal.

Subsequent to the steps described above, step S28 is executed to receive a network resource allocation response signal from the second wireless network via the handover interworking unit after the second wireless network receives the network resource allocation signal. Finally, step S29 is executed to transmit the network resource allocation response signal to the first wireless network so that the first wireless network confirms that the network resource of the second wireless network is allocated.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

In summary, according to a handover request signal from the first wireless network, the present invention selects a handover interworking unit from a plurality of interworking units for use in handover of the mobile station to the second wireless network. Specifically, as the first wireless network is now providing a first network service to the mobile station, the handover request signal comprises the information relating to the first network service. According to the information relating to the network service in the handover request signal, the present invention selects the handover interworking unit so that the bandwidth and reliability of the route provided by the handover interworking unit satisfy the needs of the first network service currently executed/received by the mobile station. Thereby, the mobile station may handover to the second wireless network smoothly and efficiently, and the shortcoming associated with using only a single interworking unit for the mobile station's handover in the prior art is overcome effectively.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A gateway module for use in a network framework, the network framework comprising a mobile station (MS), a plurality of interworking units, a first wireless network, and a second wireless network, the first wireless network having a first signal coverage and providing a first network service, the second wireless network having a second signal coverage and providing a second network service, the MS being located within the first signal coverage and the second signal coverage, the interworking units being located between the first wireless network and the second wireless network, the MS being connected to the first network service beforehand, the gateway module comprising:
a reception module, being configured to receive a handover request signal from the first wireless network;
a process module, being configured to select a handover interworking unit from the interworking units according to the handover request signal; and
a transmission module, being configured to transmit the handover request signal to the second wireless network via the handover interworking unit so that the MS may handover to the second wireless network to connect to the second network service.

2. The gateway module of claim 1, wherein the handover request signal comprises MS information and session information, the process module selects the handover interworking unit from the interworking units according to the MS information and the session information.

3. The gateway module of claim 1, wherein the reception module further receives a handover response signal, having base station (BS) candidate information of the second wireless network, from the second wireless network via the handover interworking unit after the second wireless network receives the handover request signal, the transmission module transmits the handover response signal to the first wireless network so that the first wireless network receives the BS candidate information of the second wireless network.

4. The gateway module of claim 1, wherein the reception module is further configured to receive a network resource allocation signal from the first wireless network, the transmission module transmits the network resource allocation signal to the second wireless network via the handover interworking unit so that the second wireless network allocates a network resource of the second wireless network according to the network resource allocation signal.

5. The gateway module of claim 4, wherein the reception module further receives a network resource allocation response signal from the second wireless network via the handover interworking unit after the second wireless network receives the network resource allocation signal, the transmission module transmits the network resource allocation response signal to the first wireless network so that the first wireless network confirms that the network resource of the second wireless network is allocated.

6. A communication method for use in a gateway module, the gateway module being adapted to a network framework, the network framework comprising a MS, a plurality of interworking units, a first wireless network, and a second wireless network, the first wireless network having a first signal coverage and providing a first network service, the second wireless network having a second signal coverage and providing a second network service, the MS being located within the first signal coverage and the second signal coverage, the interworking units being located between the first wireless network and the second wireless network, the MS being connected to the first network service beforehand, the communication method comprising the steps of:
receiving a handover request signal from the first wireless network;
selecting a handover interworking unit from the interworking units according to the handover request signal; and
transmitting the handover request signal to the second wireless network via the handover interworking unit so that the MS may handover to the second wireless network to connect to the second network service.

7. The communication method of claim 6, wherein the handover request signal comprises MS information and session information, the step of selecting the handover interworking unit further comprises the step of:
selecting the handover interworking unit from the interworking units according to the MS information and the session information.

8. The communication method of claim 6, further comprising the steps of:
receiving a handover response signal, having BS candidate information of the second wireless network, from the second wireless network via the handover interworking unit after the second wireless network receives the handover request signal; and
transmitting the handover response signal to the first wireless network so that the first wireless network receives the BS candidate information of the second wireless network.

9. The communication method of claim 6, further comprising the steps of:
receiving a network resource allocation signal from the first wireless network; and
transmitting the network resource allocation signal to the second wireless network via the handover interworking unit so that the second wireless network allocates a network resource of the second wireless network according to the network resource allocation signal.

10. The communication method of claim 9, further comprising the steps of:
receiving a network resource allocation response signal from the second wireless network via the interworking unit after the second wireless network receives the network resource allocation signal; and
transmitting the network resource allocation response signal to the first wireless network so that the first wireless network confirms that the network resource of the second wireless network is allocated.

11. A computer program product, storing a program of a communication method for use in a gateway module, the gateway module being adapted to a network framework, the network framework comprising a MS, a plurality of interworking units, a first wireless network, and a second wireless network, the first wireless network having a first signal coverage and providing a first network service, the second wireless network having a second signal coverage and providing a second network service, the MS being located within the first signal coverage and the second signal coverage, the interworking units being located between the first wireless network and the second wireless network, the MS being connected to the first network service beforehand, the program being loaded into the gateway module by a computer and comprising:
a program instruction A for a reception module to receive a handover request signal from the first wireless network;
a program instruction B for a process module to select a handover interworking unit from the interworking units according to the handover request signal; and
a program instruction C for a transmission module to transmit the handover request signal to the second wireless network via the handover interworking unit so that the MS may handover to the second wireless network to connect to the second network service.

12. The computer program product of claim 11, wherein the handover request signal comprises MS information and session information, the program instruction B further comprises:
a program instruction B1 for the process module to select the handover interworking unit from the interworking units according to the MS information and the session information.

13. The computer program product of claim 11, wherein the program further comprises:
a program instruction D for the reception module to receive a handover response signal, having BS candidate information of the second wireless network, from the second wireless network via the handover interworking unit after the second wireless network receives the handover request signal; and
a program instruction E for the transmission module to transmit the handover response signal to the first wireless network so that the first wireless network receives the BS candidate information of the second wireless network.

14. The computer program product of claim 11, wherein the program further comprises:
a program instruction D for the reception module to receive a network resource allocation signal from the first wireless network; and
a program instruction E for the transmission module to transmit the network resource allocation signal to the second wireless network via the handover interworking unit so that the second wireless network allocates a network resource of the second wireless network according to the network resource allocation signal.

15. The computer program product of claim 14, wherein the program further comprises:
a program instruction F for the reception module to receive a network resource allocation response signal from the second wireless network via the handover interworking unit after the second wireless network receives the network resource allocation signal.; and
a program instruction G for the transmission module to transmit the network resource allocation response signal to the first wireless network so that the first wireless network confirms that the network resource of the second wireless network is allocated.
